(19) United States
(12) Patent Application Publication
(10) Pub. No.: US 2015/0199016 A1
(43) Pub. Date: Jul. 16, 2015

(54) MOBILE TERMINAL DEVICE AND PASSWORD INPUT METHOD

(71) Applicant: KYOCERA Corporation, Kyoto-shi (JP)

(72) Inventors: Atsushi SUZUKI, Nishinomiya-shi (JP); Tatsuya IZUMI, Osaka (JP); Masayuki ONO, Akashi-shi (JP); Yoshinori KIDA, Osaka (JP)

(73) Assignee: KYOCERA Corporation

(21) Appl. No.: 14/670,317

(22) Filed: Mar. 26, 2015

Related U.S. Application Data
(63) Continuation of application No. PCT/JP2013/074991, filed on Sep. 17, 2013.

(30) Foreign Application Priority Data
Sep. 26, 2012 (JP) 2012-212920

(51) Int. Cl. G06F 3/01; G06F 3/041

(52) U.S. Cl. CPC G06F 3/016; G06F 3/041

(57) ABSTRACT

A mobile terminal device is provided with a display module including a display surface; a detection module configured to detect the position on the display surface having been touched by a user; a tactile sense information output module configured to output tactile sense information; an output control module configured to control the tactile sense information output module; a region setting module configured to set, on the display surface, a plurality of input regions each of which information constituting a password is assigned to; and a determination module configured to determine, based on a detection result by the detection module, whether or not any of the input regions has been touched. When the determination module determines that any of the input regions has been touched, the output control module makes the tactile sense information output module output the tactile sense information corresponding to the information assigned to the touched input region.

This application claims priority under 35 U.S.C. Section 119 of Japanese Patent Application No. 2012-212920 filed Sep. 26, 2012, entitled “MOBILE TERMINAL DEVICE, PROGRAM, AND PASSWORD INPUT METHOD”. The disclosure of the above application is incorporated herein by reference.

### FIELD

Embodiments of the present disclosure relate to a mobile terminal device such as a mobile phone, a PDA (Personal Digital Assistant), a tablet PC, and an electronic book terminal. Embodiments of the present disclosure also relate to a password input method suitable for use in the mobile terminal device.

### BACKGROUND

Conventionally, a mobile terminal device such as a mobile phone allows a password to be set so as to protect personal information.

The password is constituted of a plurality of digits, for example. The mobile terminal device includes an input key group used for inputting the digits. On each of input keys that constitute the input key group, a digit assigned to the input key is displayed.

### SUMMARY

A mobile terminal device according to a first aspect of the disclosure is provided with a display module including a display surface; a detection module configured to detect the position on the display surface having been touched by a user; a tactile sense information output module configured to output tactile sense information; an output control module configured to control the tactile sense information output module; a region setting module configured to set, on the display surface, a plurality of input regions each of which information constituting a password is assigned to; and a determination module configured to determine, based on a detection result by the detection module, whether or not any of the input regions has been touched. When the determination module determines that any of the input regions has been touched, the output control module makes the tactile sense information output module output the tactile sense information corresponding to the information assigned to the touched input region.

Here, the information constituting a password indicates a digit, character, or symbol constituting the password.

A second aspect of the disclosure relates to a password input method for a mobile terminal device provided with a display module including a display surface; a detection module configured to detect that the display surface has been touched; and a tactile sense information output module configured to output tactile sense information. The password input method according to the second aspect includes: setting, on the display surface, a plurality of input regions each of which information constituting a password is assigned to; determining, based on a detection result by the detection module, whether or not any of the input regions has been touched; and when any of the input regions has been touched, making the tactile sense information output module output the tactile sense information corresponding to the information assigned to the touched input region.

### BRIEF DESCRIPTION OF THE DRAWINGS

FIG. 1A and FIG. 1B are illustrations of diagrams illustrating a configuration of a mobile phone according to an embodiment of the disclosure;

FIG. 2A to FIG. 2D are illustrations of diagrams illustrating a configuration of a vibration actuator in the embodiment;

FIG. 3 is an illustration of a block diagram illustrating the entire configuration of the mobile phone in the embodiment;

FIG. 4A and FIG. 4B are illustrations of diagrams for describing a password input screen in the embodiment;

FIG. 5 is an illustration of a diagram illustrating a vibration pattern table in the embodiment;

FIG. 6 is an illustration of a flowchart illustrating a password unlock process in the embodiment;

FIG. 7 is an illustration of another flowchart illustrating the password unlock process in the embodiment;

FIG. 8A to FIG. 8C are illustrations of diagrams illustrating drive states of the vibration actuator when an input operation to the password input screen is performed in the embodiment;

FIG. 9 is an illustration of a diagram illustrating a vibration pattern table in a first modification;

FIG. 10A to FIG. 10C are illustrations of diagrams illustrating input regions set on the password input screen in a second modification;

FIG. 11A and FIG. 11B are illustrations of diagrams illustrating input regions set on the password input screen in another modification; and

FIG. 12A and FIG. 12B are illustrations of diagrams illustrating a configuration of the password input screen in yet another modification.

The drawings are provided mainly for describing the present disclosure, and do not limit the scope of the present disclosure.

### DESCRIPTION OF PREFERRED EMBODIMENTS

In the following, an embodiment of the disclosure is described referring to the drawings.

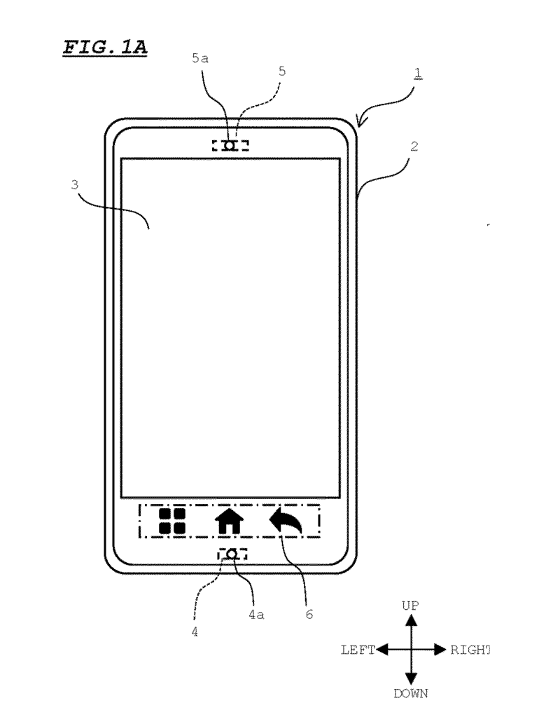

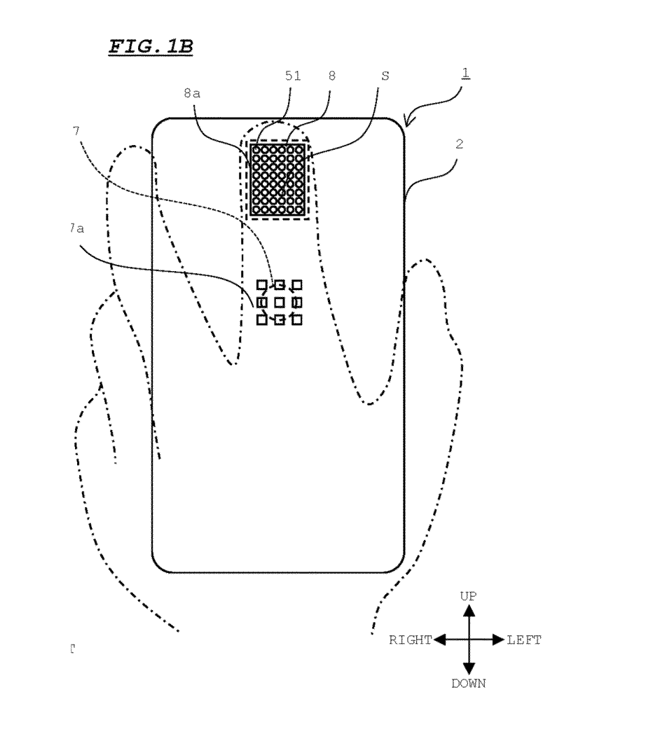

FIG. 1A and FIG. 1B are illustrations of diagrams illustrating a configuration of a mobile phone 1. FIG. 1A and FIG. 1B are respectively a front view and a rear view of the mobile phone 1.

In the following, to simplify the description, as illustrated in FIG. 1A and 1B, the long side direction of a cabinet 2 is defined as up and down directions, and the short side direction of the cabinet 2 is defined as left and right directions.

The mobile phone 1 may be provided with the cabinet 2, a display surface 3, a microphone 4, a call speaker 5, a key operation part 6, and an external speaker 7.

The cabinet 2 may have a substantially rectangular contour when viewed from the front side. The display surface 3 of a display module 13 to be described later may be located on the front surface of the cabinet 2. Various images (screens) are displayed on the display surface 3.

The microphone 4 may be located at a lower end within the cabinet 2, and the call speaker 5 may be located at an upper end within the cabinet 2. Sound is input into the microphone through a microphone hole 4a formed in the front surface of the cabinet 2. The microphone 4 generates an electrical signal in accordance with input sound. Sound is output from the call speaker 5. Sound output from the call speaker 5 is released to the outside through an output hole 5a formed in the front surface of the cabinet 2.

The key operation part 6 may be located on the front surface of the cabinet 2. The key operation part 6 may be constituted of a plurality of operation keys. Various functions for operating a program being executed are assigned to the operation keys.

The external speaker 7 may be located in the cabinet 2. Output holes 7a associated with the external speaker 7 are formed in the back surface of the cabinet 2. Sound (voice, alarm, or the like) output from the external speaker 7 is released to the outside through the output holes 7a.

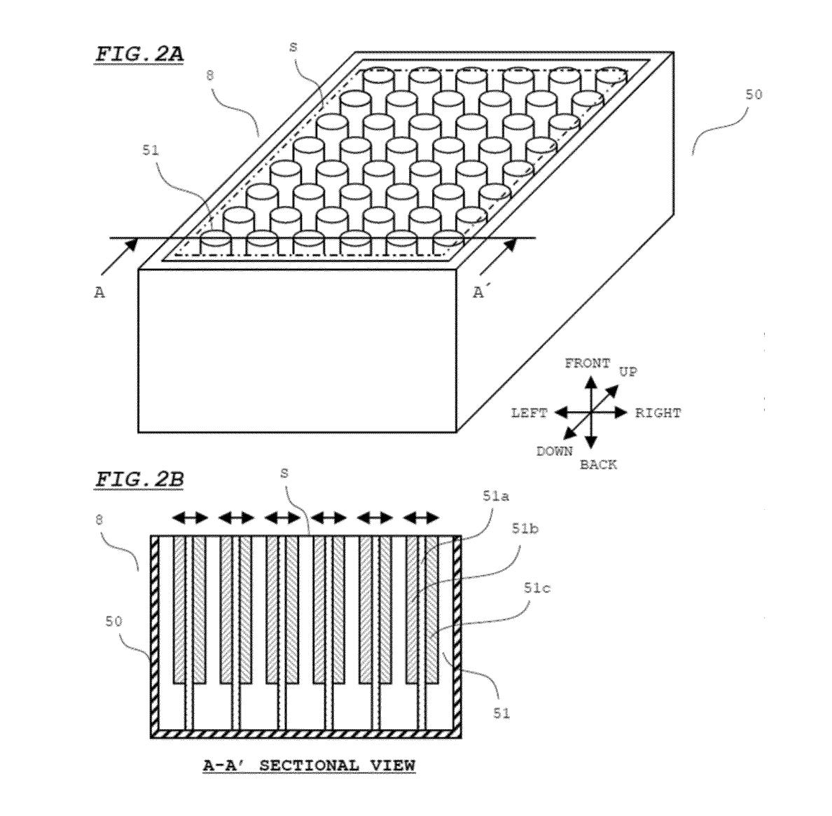

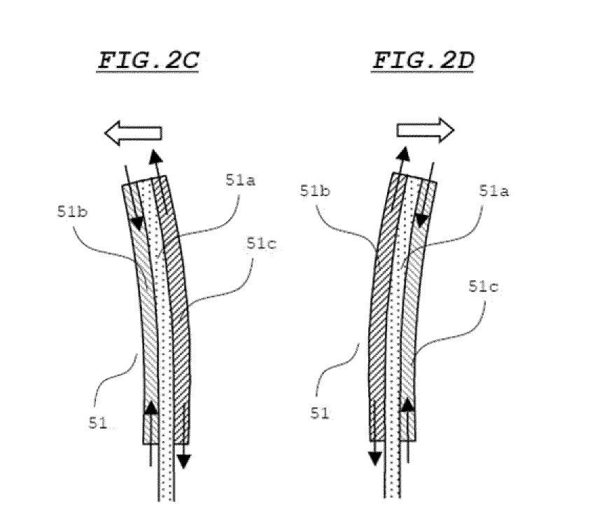

A vibration actuator 8 may be also located in an upper part in the cabinet 2. FIG. 2A to FIG. 2D illustrate a configuration of the vibration actuator 8. FIG. 2A is an illustration of a perspective view illustrating the configuration of the vibration actuator 8. FIG. 2B is an illustration of a sectional view taken along the line A-A′ of FIG. 2A. FIG. 2C and FIG. 2D are illustrations of diagrams illustrating the operation of each of vibration elements 51 constituting the vibration actuator 8.

The vibration actuator 8 may be constituted of a case 50 whose upper surface is open, and a plurality of round-bar-like vibration elements 51 arranged in a matrix inside the case 50. The vibration actuator 8 may be constituted of 48 vibration elements 51 that are arranged in 8 rows in up and down directions and 6 columns in left and right directions, for example. The tips of the vibration elements 51 arranged in the matrix form a vibration surface S of the vibration actuator 8.

As illustrated in FIG. 2B, each vibration element 51 may be provided with a shim material 51a, and a first piezoelectric element 51b and second piezoelectric element 51c mounted on respective sides of the shim material 51a.

AC (alternating current) voltages that include a positive voltage and a negative voltage and have opposite phases are applied to the first piezoelectric element 51b and second piezoelectric element 51c, respectively. When the AC voltages are applied, the operation of FIG. 2C in which the first piezoelectric element 51b contracts and the second piezoelectric element 51c expands and the operation of FIG. 2D in which the first piezoelectric element 51b expands and the second piezoelectric element 51c contracts are repeated. Thus, the vibration element 51 vibrates laterally.

In FIG. 1A and FIG. 1B, an opening 8a corresponding to the vibration actuator 8 may be formed in the back surface of the cabinet 2. The matrix-like vibration elements 51 are exposed to the outside through the opening 8a. The vibration surface S of the vibration actuator 8 may be substantially flush with the back surface of the cabinet 2. When a password is input (described later), as illustrated in FIG. 1B, the user holds the back surface of the cabinet 2 with one hand and touches the vibration surface S of the vibration actuator 8 with the index finger of the hand.

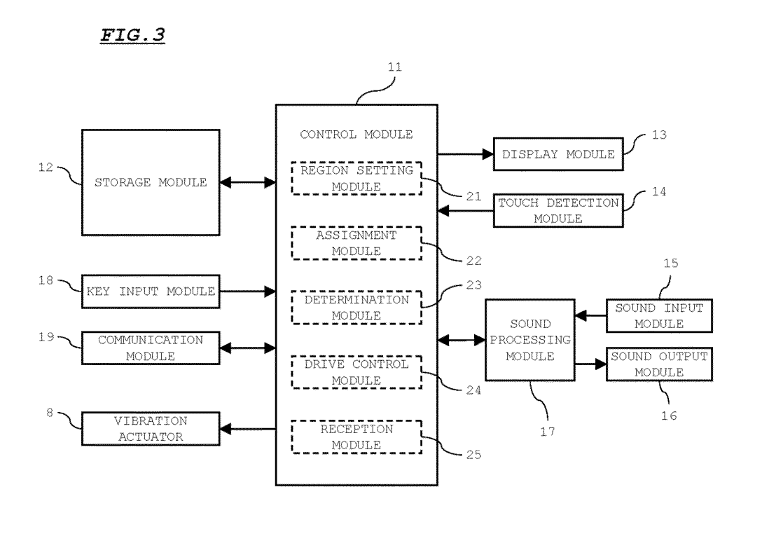

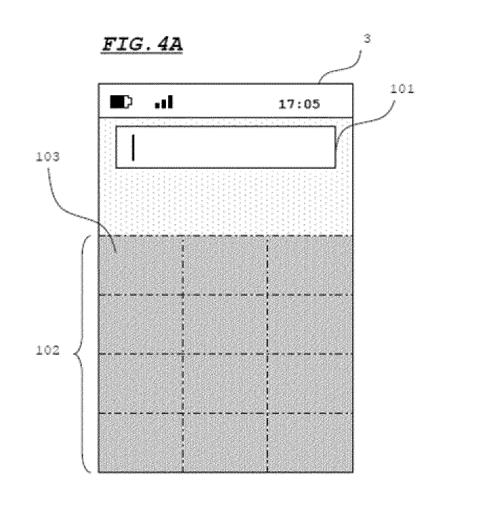

FIG. 3 is an illustration of a block diagram illustrating the entire configuration of the mobile phone 1. The mobile phone 1 may be provided with a control module 11, a storage module 12, the display module 13, a touch detection module 14, a sound input module 15, a sound output module 16, a sound processing module 17, a key input module 18, a communication module 19, and the vibration actuator 8.

The storage module 12 may be constituted of an ROM, an RAM, an external memory, and the like. The storage module 12 stores therein various programs. The programs stored in the storage module 12 include, in addition to a control program for controlling the modules of the mobile phone 1, various applications (e.g. applications relating to a phone, an email, a phone book, a map, a game, and a schedule management). The programs may be stored in the storage module 12 when the mobile phone 1 is manufactured by the manufacturer, or may be stored in the storage module 12 by the user via a communication network or a storage medium.

The storage module 12 also may include a working area in which data to be temporarily used or generated is stored when a program is executed.

The control module 11 may be constituted of a CPU and the like. The control module 11 controls the modules constituting the mobile phone 1 (such as the storage module 12, the display module 13, the touch detection module 14, the sound input module 15, the sound output module 16, the sound processing module 17, the key input module 18, the communication module 19, and the vibration actuator 8) in accordance with a program.

The display module 13 may be constituted of a liquid crystal display and the like. The display module 13 displays an image (a screen) on the display surface 3, based on a control signal and an image signal from the control module 11. The display module 13 may be constituted of the display device such as an organic EL display, in place of a liquid crystal display.

The touch detection module 14 may be constituted of a touch panel configured to detect touch of the display surface 3 by the fingertip. The touch panel may be formed of a transparent sheet-like member, and may be located on the front surface of the cabinet 2 while covering the display surface 3. The touch panel may be any one of various types of touch panels such as an electrostatic capacitive touch panel, an ultrasonic touch panel, a pressure sensitive touch panel, a resistive touch panel, and a photosensitive touch panel.

The touch detection module 14 detects a position on the display surface 3 where the fingertip has touched as a touch position, and outputs a position signal in accordance with the detected touch position to the control module 11.

The user is allowed to perform various touch operations by touching the display surface 3 by the fingertip. Examples of the touch operations are a tap operation, a flick operation, and a slide operation. The tap operation is an operation of touching the display surface 3 by the fingertip, and then releasing the fingertip from the display surface 3 within a short time. The flick operation is an operation of flipping the display surface 3 in an arbitrary direction with the fingertip. The slide operation is an operation of moving the fingertip on the display surface 3 in an arbitrary direction while keeping the fingertip in contact with the display surface 3. The flick operation and the slide operation are touch operations accompanying movement of a touch position.

The touch operations are described in detail. For instance, after a touch position with respect to the display surface 3 is detected by the touch detection module 14, when the touch position cannot be detected any more within a predetermined first time, the control module 11 determines that a tap operation has been performed. After a touch position with respect to the display surface 3 is detected by the touch detection module 14 and the touch position is moved by a predetermined first distance or more within a predetermined second time, when the touch position cannot be detected any more, the control module 11 determines that a flick operation has been performed. After a touch position with respect to the display surface 3 is detected by the touch detection module 14, when the touch position is moved by a predetermined second distance or more, the control module 11 determines that a slide operation has been performed.

The sound input module 15 may be constituted of the microphone 4 and the like. The sound input module 15 outputs an electrical signal from the microphone 4 to the sound processing module 17.

The sound output module 16 may include the call speaker 5 and the external speaker 7. The sound output module 16 receives an electrical signal from the sound processing module 17, and outputs sound (voice, alarm, or the like) from the call speaker 5 or from the external speaker 7.

The voice sound module 17 performs e.g. A/D conversion to an electrical signal from the sound input module 15, and outputs a digital sound signal which has undergone ND conversion to the control module 11. The sound processing module 17 performs e.g. a decoding process and D/A conversion to the digital sound signal output from the control module 11, and outputs an electrical signal which has undergone D/A conversion to the sound output module 16.

The key input module 18 outputs, to the control module 11, a signal associated with each one of the operation keys when the operation keys in the key operation part 6 are pressed.

The communication module 19 may be provided with a circuit for converting a signal, and an antenna for transmitting and receiving a radio wave in order to make a phone call or to perform communication. The communication module 19 converts a signal to be input from the control module 11 for a phone call or for communication into a wireless signal, and transmits the converted wireless signal to a communication destination such as a base station or another communication device via the antenna. Further, the communication module 19 converts the wireless signal received via the antenna into a signal of a format usable by the control module 11, and outputs the converted signal to the control module 11.

The mobile phone 1 of the embodiment has a security lock function to protect personal information. The security lock function restricts functions of a terminal. In the case where the functions of the terminal are restricted by setting of the security lock function, when a predetermined password is input, the restriction of the functions is cancelled. In other words, when a password is not input, screen change to an operable screen such as a home screen is not performed, and at least some functions of the mobile phone 1 cannot be used.

When the mobile phone 1 is not used for a predetermined time without a key operation, namely when a touch operation to the display surface 3 and a key operation to the key operation part 6 are not performed for the predetermined time, a power saving function is executed, the light of the display module 13 is turned off, and a touch operation to the display surface 3 is not received.

In the case where the security lock function is set, when an operation of finishing the power saving function, such as an operation of pressing a predetermined key of the key operation part 6, is performed, the control module 11 executes a password unlock process. The password input screen is displayed on the display surface 3, and the user inputs a password. When the input password matches with a previously registered password, the password is unlocked. Thus, the setting of the security lock function is cancelled, and the screen on the display surface 3 is switched from the password input screen to an operable screen, for example, to the home screen.

In the embodiment, in order to prevent another person from knowing the password when the person sees the password input screen while the user is inputting the password, the password unlock process using the vibration actuator 8 is executed. In the embodiment, the password is constituted of a plurality of digits, for example.

In order to execute the password unlock process, the control module 11 may be provided with a region setting module 21, an assignment module 22, a determination module 23, a drive control module 24, and a reception module 25.

The control module 11 displays the password input screen on the display surface 3 in the password unlock process.

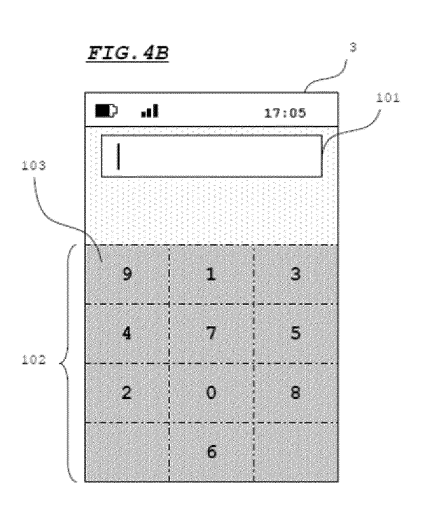

FIG. 4A and FIG. 4B are illustrations of diagrams for describing the password input screen. As illustrated in FIG. 4A, the password input screen includes a display box 101 and a non-display region 102.

The display box 101 is provided to report an input state of a password. On the display box 101, a symbol, for example, “*”, is displayed instead of a digit input as a password. In the non-display region 102, no image is displayed, and a black screen is displayed.

In order to receive the input of a password, the region setting module 21 sets a plurality of input regions 103 on the display surface 3, namely in the non-display region 102 on the password input screen. Here, digits for constituting a password are assigned to the input regions 103, respectively, as illustrated in FIG. 4B. The input regions 103 are arranged in a matrix in the non-display region 102.

The assignment module 22 assigns each digit to each input region 103 set by the region setting module 21. FIG. 4B illustrates the state where each digit is assigned to each input region 103. Actually, the digits assigned to the input regions 103 are not displayed on the password input screen. The assignment module 22 changes the assignment of each digit to each input region 103 so that a digit different from the previous digit is assigned to each input region 103 whenever a new password input screen is displayed.

The determination module 23 determines, based on a detection result by the touch detection module 14, whether or not any input region 103 has been touched. The determination module 23 also determines, based on the detection result by the touch detection module 14, whether or not a user's finger having touched the input region 103 is released.

The drive control module 24 drives the vibration actuator 8. The drive control module 24 individually controls the vibration elements 51 by individually supplying AC voltages to the vibration elements 51.

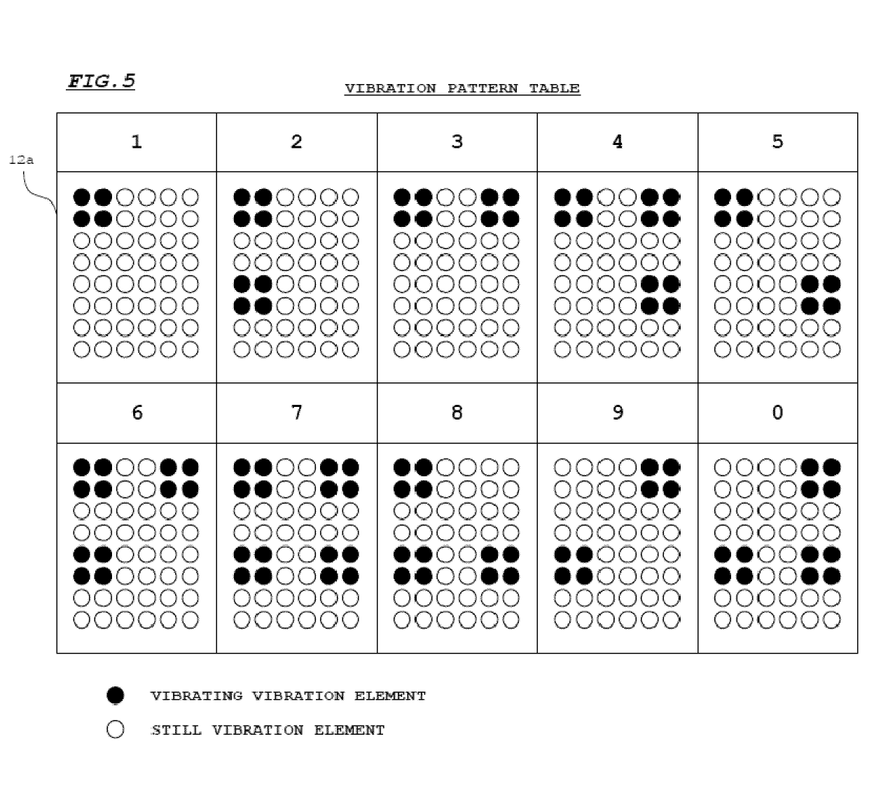

In the storage module 12, a vibration pattern table 12a used for driving the vibration actuator 8 is stored. FIG. 5 illustrates the vibration pattern table 12a.

On the vibration pattern table 12a, Braille characters are stored which correspond to the digits of “0” to “9” and are formed on the vibration surface S of the vibration actuator 8 based on the presence or absence of the vibration of each vibration element 51. The Braille characters are associated with the digits of “0” to “9” constituting a password. In FIG. 5, a vibrating vibration element 51 is denoted with a black circle, and a still vibration element 51 is denoted with a white circle.

When the determination module 23 determines that any input region 103 has been touched, the drive control module 24 refers to the vibration pattern table 12a in the storage module 12, and drives each vibration element 51 of the vibration actuator 8 so as to form, on the vibration surface S, a Braille character corresponding to the digit assigned to the touched input region 103.

When the determination module 23 determines that a user's finger having touched the input region 103 is released, the reception module 25 receives, as one digit constituting a password, the digit assigned to the input region 103 from which the finger is released.

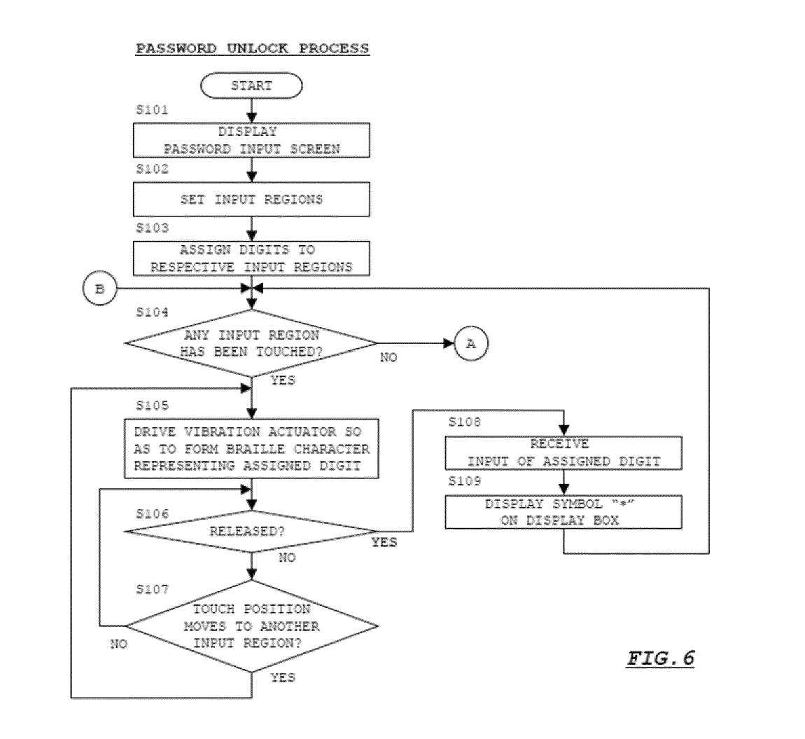

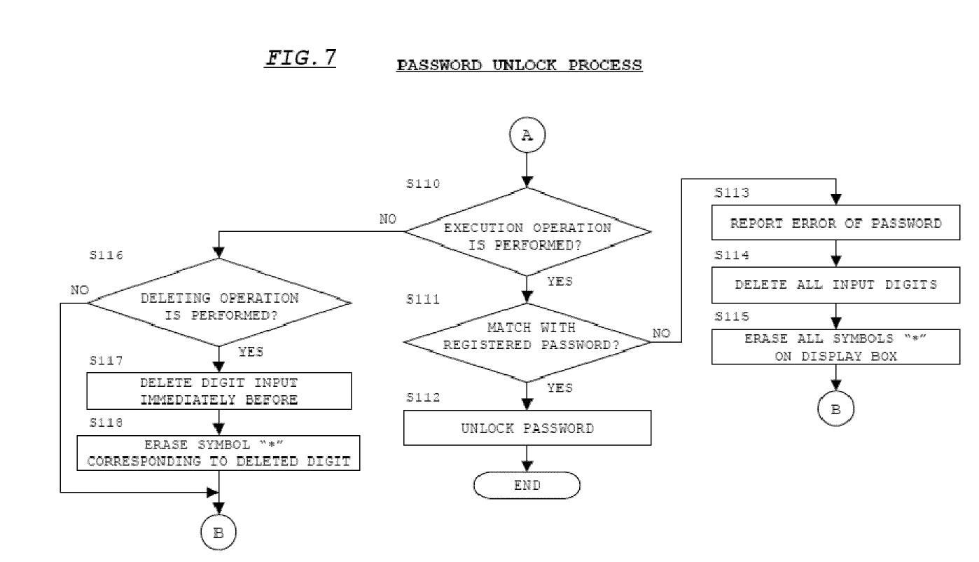

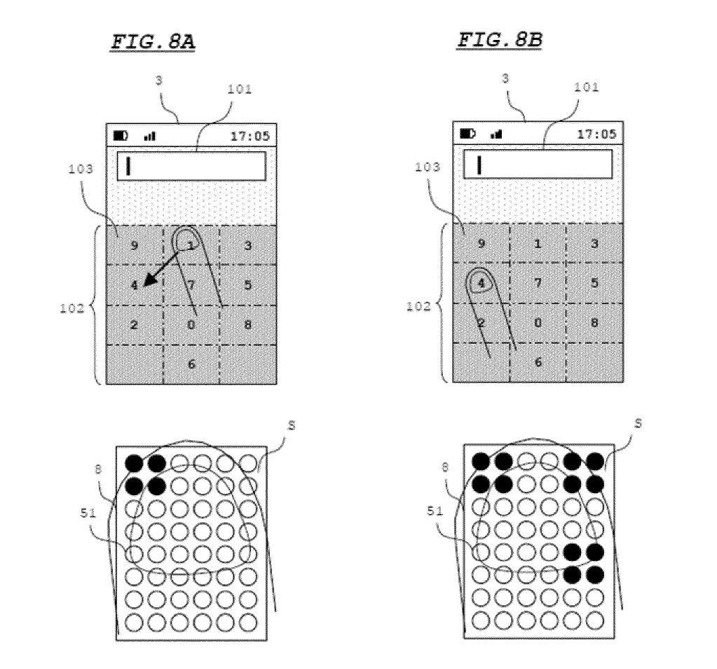

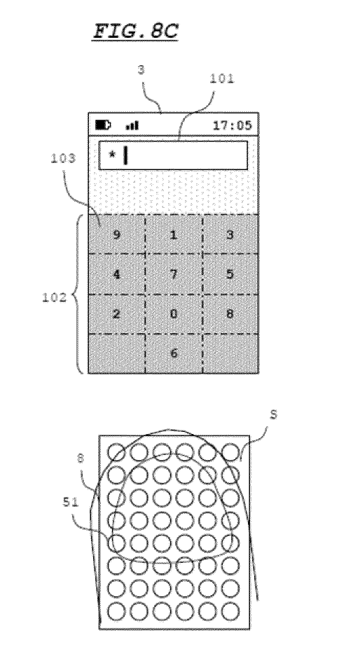

FIG. 6 and FIG. 7 are illustrations of flowcharts illustrating a password unlock process. FIG. 8A to FIG. 8C are illustrations of diagrams illustrating drive states of the vibration actuator 8 when an input operation to the password input screen is performed. In the following, the password unlock process is described referring to FIG. 6 to FIG. 8C.

When the process is started, the control module 11 displays the password input screen of FIG. 4A on the display surface 3 (S101). The control module 11 (region setting module 21) sets input regions 103 in the non-display region 102 of the password input screen (S102). The control module 11 (assignment module 22), as illustrated in FIG. 4B, randomly assigns the digits of “0” to “9” for constituting a password to respective input regions 103 (S103). Due to such random assignment of the digits, a digit different from the previous digit is assigned to each input region 103 whenever a new password input screen is displayed. However, the case may occur where the same digit as the previously assigned digit is assigned to each of one or more input regions 103.

The control module 11 (determination module 23) determines whether or not any input region 103 has been touched (S104).

The digit assigned to each input region 103 is not displayed on the password input screen, so that the user cannot know the input regions 103 to be touched for inputting the password. As illustrated in FIG. 1B, the user touches the vibration surface S of the vibration actuator 8 with the index finger of the hand that holds the mobile phone 1, and simultaneously touches an appropriate input region 103 with a finger of the other hand.

When any input region 103 has been touched (S104: YES), the control module 11 (drive control module 24) drives the vibration actuator 8 so as to form, on the vibration surface S, the Braille character corresponding to the digit assigned to the touched input region 103. For example, when the digit assigned to the touched input region 103 is “1” as illustrated in FIG. 8A, each vibration element 51 vibrates so as to form, on the vibration surface S, the Braille character corresponding to “1”. The user recognizes that the digit assigned to the touched input region 103 is “1”, by reading the Braille character with the index finger touching the vibration surface S.

The control module 11 (determination module 23) determines whether the user's finger has been released from the display surface 3 (S106). When the control module 11 (determination module 23) determines that the finger has not been released, namely that the touch on the display surface 3 is continued (S106: NO), the control module 11 (determination module 23) further determines whether the touch position on the display surface 3 has moved to another input region 103 (S107).

When the recognized digit is not the digit to be input as the password, the user moves the finger to an adjacent input region 103 while keeping the touch state on the display surface 3.

When the touch position on the display surface 3 is moved to another input region 103 (S106: NO and S107: YES), the control module 11 (drive control module 24) executes the process of step S105 again. In other words, the control module 11 (drive control module 24) drives the vibration actuator 8 so as to form, on the vibration surface S, the Braille character corresponding to the digit assigned to the input region 103 to which the finger has moved. When the digit assigned to the input region 103 to which the finger has moved is “4” as illustrated in FIG. 8B, each vibration element 51 vibrates so as to form, on the vibration surface S, the Braille character corresponding to “4”.

The user recognizes the digit assigned to the touched input region 103 by reading the Braille character formed on the vibration surface S. When the recognized digit is the digit to be input as the password, the user releases the finger from the display surface 3 in the input region 103.

When the finger is released from the display surface 3 (S106: YES), the control module 11 (reception module 25) receives an input of the digit assigned to the input region 103 from which the finger has been released (S108). As illustrated in FIG. 8C, the control module 11 displays, on the display box 101, the symbol “*” instead of the input digit (S109). By repeating the processes of the steps S104 to S109, all digits of the password are input.

The control module 11 determines whether an execution operation has been performed (S110). For example, as a key for the execution operation, a predetermined operation key of the key operation part 6 is assigned. When the input of all digits of the password is finished, the user performs the execution operation. When the control module 11 determines that the execution operation has been performed (S110: YES), the control module 11 determines whether the input password matches with a previously registered password (S111).

When the control module 11 determines that the input password matches with the registered password (S111:YES), the control module 11 unlocks the password (S112). Thus, the password unlock process is finished.

When the control module 11 determines that the input password does not match with the registered password (S111: NO), the control module 11 notifies the outside of the incorrectness of the password (S113). For example, a message window for reporting that the password is incorrect is pop-up-displayed on the password input screen. Alternatively, a sound for reporting that the password is incorrect is output from the external speaker 7.

The control module 11 deletes all of the input digits (S114). The control module 11 also erases all of the symbols “*” displayed on the display box 101 (S115). Then, the control module 11 returns to the process of the step S104, and starts to receive a password from the first digit.

When the user inputs an incorrect digit as a password, the user performs a deleting operation. As a key for the deleting operation, an operation key of the key operation part 6 is assigned. The operation key assigned as a key for the deleting operation is different from the operation key assigned as a key for the execution operation. When the user performs the deleting operation (S116: YES), the control module 11 deletes the digit input immediately before the deleting operation (S117), and erases the symbol “*” corresponding to the deleted digit in the display box 101 (S118).

In the embodiment, thus, the digit (information constituting a password) assigned to each input region 103 is not displayed on the password input screen. When the input region 103 is touched, the user can recognize the digit assigned to the touched input region 103 with the vibration pattern of the vibration elements 51 in the vibration actuator 8. Therefore, even when another person sees the password input screen while the user is inputting a password, the password is less apt to be known by the person. The arrangement of the digits set in the input regions 103 is different every time, so that the action for the input operation changes whenever the password is input. Therefore, even when an operation of unlocking the security lock function that is set in the mobile phone 1 is performed in a situation in which there are many persons around the user, such as in a train or town, the password is less apt to be known by another person.

In the embodiment, furthermore, based on the presence or absence of each vibration element 51, not the digit itself assigned to each input region 103, but the Braille character corresponding to the digit is formed on the vibration surface S of the vibration actuator 8. Therefore, the user easily recognizes the digit solely by reading the points of the Braille character represented by vibration on the vibration surface S.

In the embodiment, the vibration surface S of the vibration actuator 8 is located in an upper part on the back surface of the cabinet 2. Therefore, when the user holds the mobile phone 1 with a hand, the user can easily touch the vibration surface S with a finger (e.g. index finger) of the hand.

In the embodiment, when the user traces the input regions 103 with a finger and finds the input region 103 to which a desired digit is assigned, the digit assigned to the input region 103 is input by releasing the finger from the display surface 3 in the input region 103. Thus, the user can easily input the password.

### First Modification

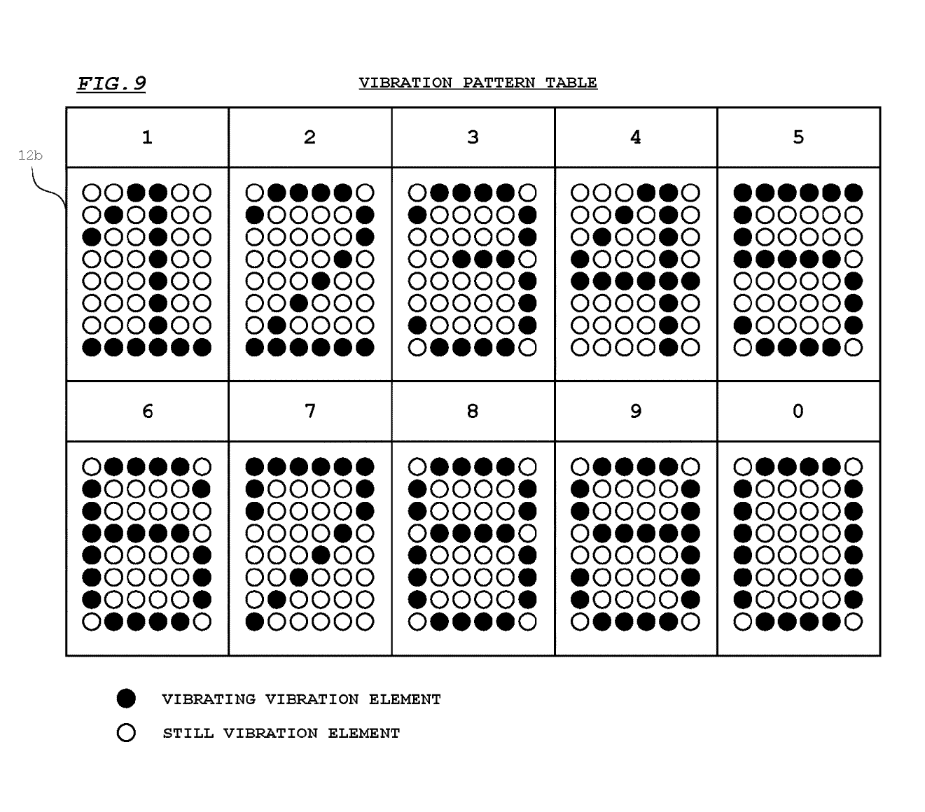

FIG. 9 is an illustration of a diagram illustrating a vibration pattern table 12b in the first modification. In the first modification, instead of the vibration pattern table 12a of FIG. 5, the vibration pattern table 12b is stored in the storage module 12.

On the vibration pattern table 12b, the digits of “0” to “9” formed on the vibration surface S of the vibration actuator 8 based on the presence or absence of the vibration of each vibration element 51 are stored in association with the digits of “0” to “9” constituting a password.

In the first modification, when the determination module 23 determines that any input region 103 has been touched, the drive control module 24 refers to the vibration pattern table 12b of the storage module 12, and drives each vibration element 51 of the vibration actuator 8 so as to form, on the vibration surface S, the digit assigned to the touched input region 103.

In this configuration, the digit assigned to each input region 103 is formed as it is on the vibration surface S of the vibration actuator 8, so that the user does not need to remember the Braille character corresponding to each digit.

### Second Modification

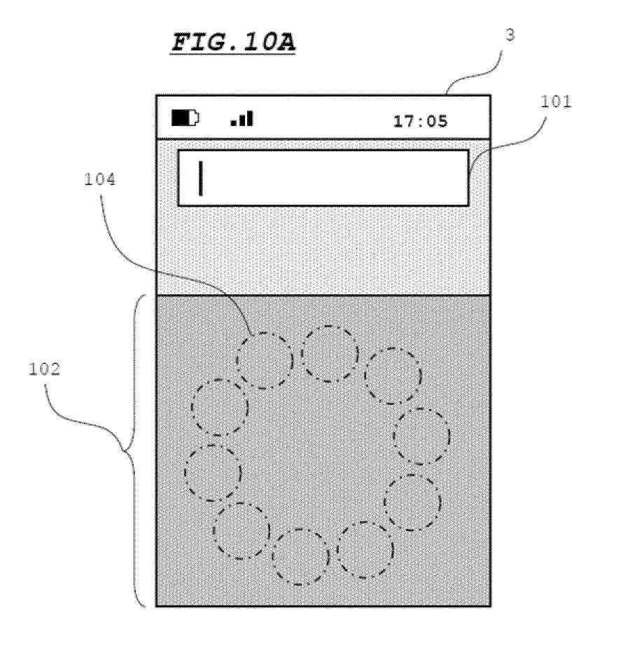

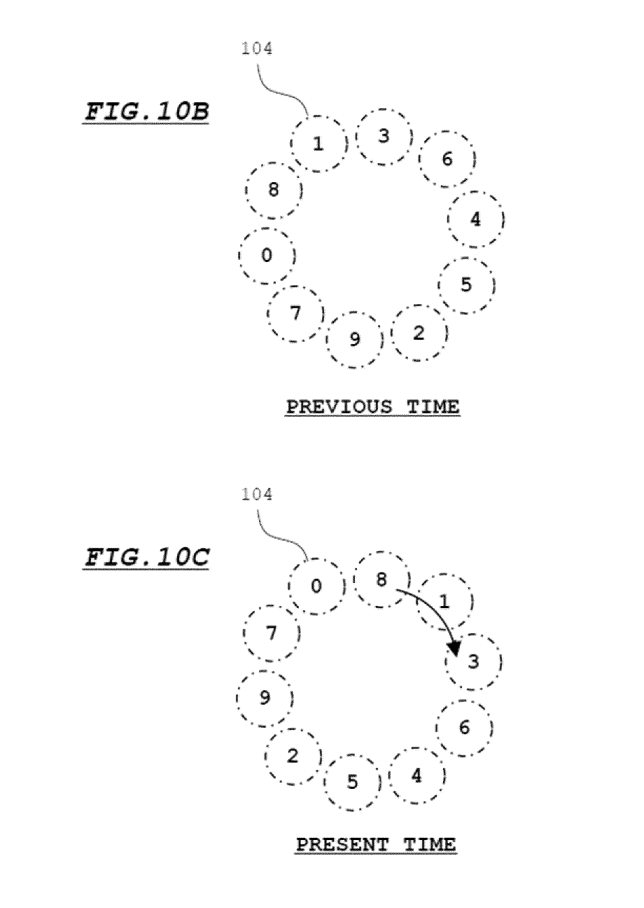

FIG. 10A to FIG. 10C are illustrations of diagrams illustrating input regions 104 set on the password input screen in the second modification.

As illustrated in FIG. 10A, the region setting module 21 sets a plurality of input regions 104 arranged annularly in the non-display region 102 on the password input screen. As illustrated in FIG. 10B and FIG. 10C, when a new password input screen is displayed on the display surface 3, assignment module 22 changes the digit assigned to each input region 104 without changing the arrangement sequence of the digits by rotating the digits clockwise or counterclockwise by a predetermined number of input regions 104.

In this configuration, by remembering the arrangement sequence of the digits in advance, the user recognizes which digit is assigned to the firstly touched input region 104, and then can easily find a desired input region 104.

### Others

The embodiment and the modifications of the present disclosure have been described as above. The present disclosure, however, is not limited to the foregoing embodiment and the modifications, and the embodiment of the present disclosure may be modified in various ways other than the above.

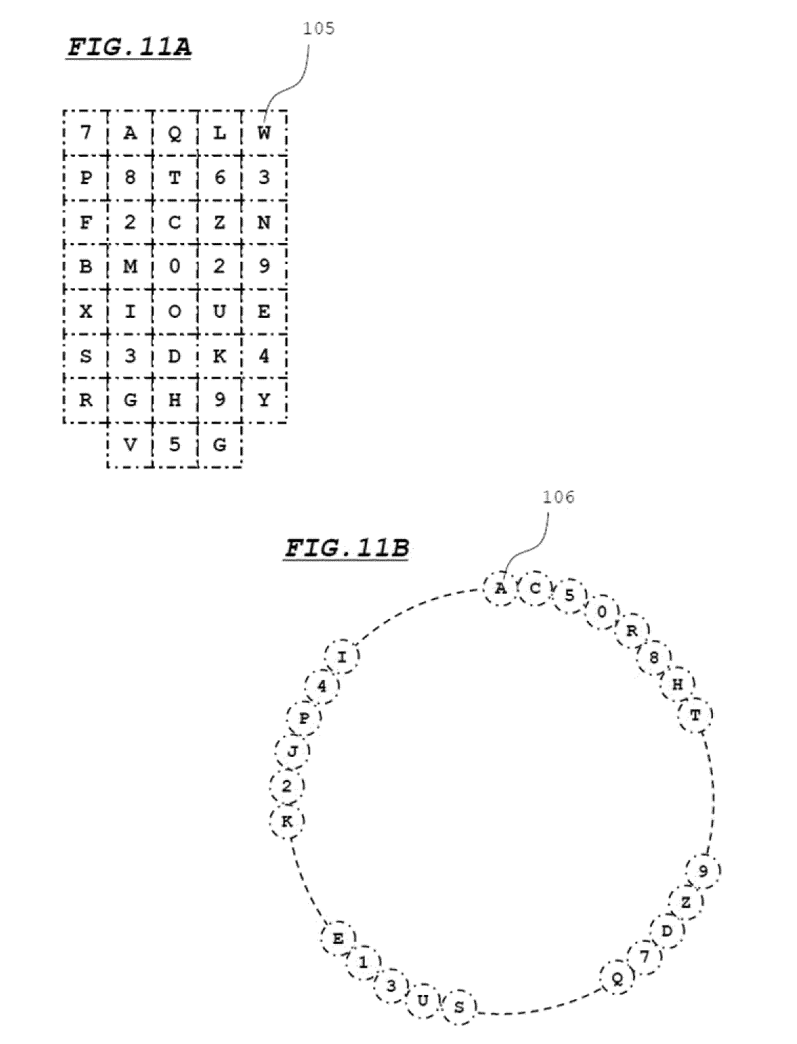

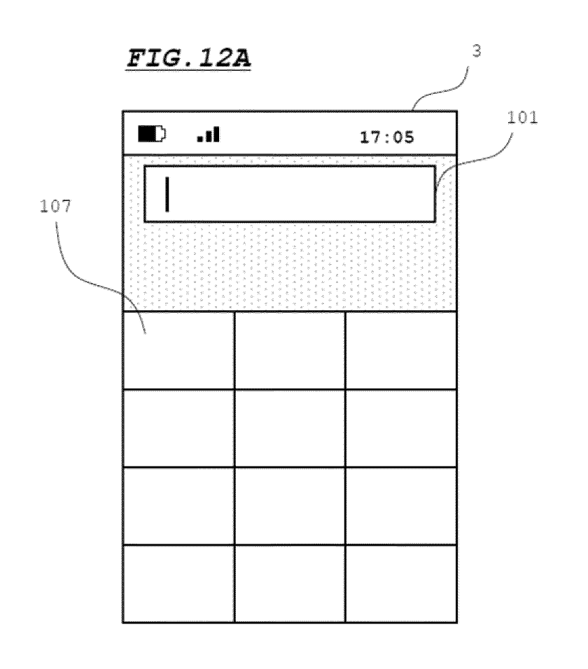

In the embodiment, for example, digits are used as information constituting a password. However, for example, as the information constituting a password, symbols and characters such as alphabets may be used instead of the digits or in addition to the digits. For example, when digits and alphabets are used as the information constituting the password, as illustrated in FIG. 11A, a plurality of matrix-like input regions 105 to which the alphabets and digits are assigned are set on the display surface 3, namely on the password input screen. Alternatively, as illustrated in FIG. 11B, a plurality of annularly arranged input regions 106 to which the alphabets and digits are assigned are set on the display surface 3, namely on the password input screen. In FIG. 11B, the illustration of some input regions 106 is omitted, the omitted parts are shown by broken lines.

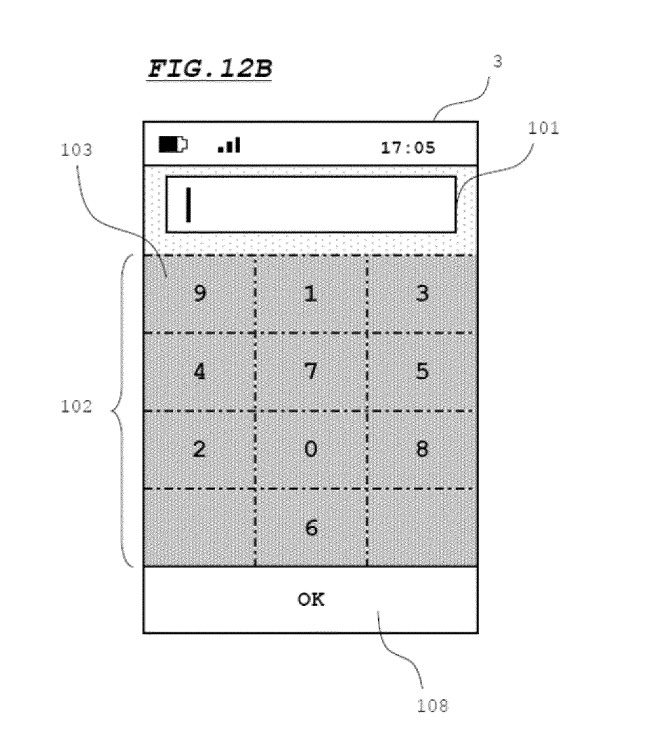

In the embodiment, furthermore, an image indicating each input region 103 is not displayed on the display surface 3. However, as illustrated in FIG. 12A, each input region 107 may be displayed as an image ,for example, an image of a quadrangular key, on the display surface 3. Also in this case, however, a digit assigned to each input region 107 is not displayed in the input region 107.

In the embodiment, furthermore, as a key for the execution operation after the input of a password, an operation key of the key operation part 6 is assigned. However, as illustrated in FIG. 12B, an OK key 108 for the execution operation may be located on the password input screen. Similarly, a key for a deleting operation may be located on the password input screen.

In the embodiment, furthermore, whenever a new password input screen is displayed on the display surface 3, the digit (information constituting a password) assigned to each input region 103 is changed. However, differently from the above-mentioned case, the assignment of the digits may be changed not each time, but every several times. Furthermore, the digit assigned to each input region 103 may be fixed and does not need to be changed. In this case, the digits are arranged sequentially from “1”.

In the embodiment, furthermore, when the finger having touched the input region 103 is released, the digit (information constituting a password) assigned to the input region 103 is input as a password. However, the operation whose input is received is not limited to such an operation. For example, when the finger having touched input region 103 is released, and, within a certain time after that, the same input region 103 is touched, the digit assigned to the input region 103 may be received as a password. Thus, an accident in which release of the finger by mistake causes an input of an incorrect digit is suppressed.

In the embodiment, furthermore, the vibration surface S of the vibration actuator 8 is located in an upper part on the back surface of the cabinet 2. However, the vibration surface S may be located at any position of the cabinet 2 as long as the position can be touched with the finger.

In the embodiment, furthermore, digits (information constituting a password) are output as tactile sense information, so that a vibration actuator 8 is used as a tactile sense information output module. However, an actuator having another configuration may be employed as a tactile sense information output module as long as the configuration outputs the information constituting a password as the tactile sense information. For example, an actuator may be employed which is configured to include a plurality of pins that are arranged in a matrix and can project forward from a contact surface and to form a digit with the pins projecting from the contact surface. In this case, the pins projecting so as to form a digit come into contact with the user' finger touching the contact surface, thereby allowing the user to read the digit.

The disclosure is not limited to a mobile phone, but may be applied to various kinds of mobile terminal devices such as a PDA (Personal Digital Assistant), a tablet PC, and an electronic book terminal.

The embodiment of the disclosure may be changed or modified in various ways as necessary within the technical scope of the claims of the present disclosure hereinafter defined.

What is claimed is:

1. A mobile terminal device comprising:
a display module including a display surface;
a detection module configured to detect a position on the display surface having been touched by a user;
a tactile sense information output module configured to output tactile sense information;
an output control module configured to control the tactile sense information output module;
a region setting module configured to set a plurality of input regions on the display surface, information constituting a password being assigned to each of the input regions; and
a determination module configured to determine, based on a detection result by the detection module, whether or not any of the input regions has been touched,
wherein, when the determination module determines that any of the input regions has been touched, the output control module makes the tactile sense information output module output the tactile sense information corresponding to the information assigned to the touched input region.

2. The mobile terminal device according to claim 1, wherein
the tactile sense information output module includes a vibration actuator including a plurality of vibration elements, the plurality of vibration elements being arranged in a matrix and forming a vibration surface, and
the output control module controls the vibration actuator so that a pattern corresponding to the information assigned to the touched input region is formed on the vibration surface based on presence or absence of vibration of each of the vibration elements.

3. The mobile terminal device according to claim 2, wherein
the information includes a digit or a character, and
the pattern includes a Braille character corresponding to the digit or the character.

4. The mobile terminal device according to claim 1, further comprising
an assignment module configured to assign the information to each of the input regions set by the region setting module,
wherein the assignment module changes the information assigned to the input regions.

5. The mobile terminal device according to claim 1, wherein
the region setting module annularly arranges the plurality of input regions on the display surface, and
the assignment module changes the information assigned to the input regions so that an arrangement sequence of the information is not changed.

6. The mobile terminal device according to claim 1, wherein
the display surface is located on a front surface of a cabinet of the mobile terminal device, and
the tactile sense information output module is located on a back surface of the cabinet.

7. The mobile terminal device according to claim 1, wherein
the determination module determines, based on a detection result by the detection module, whether a user's finger having touched the input region is released, and
the mobile terminal device further comprises a reception module configured to, when the determination module determines that the user's finger having touched the input region is released, receive the information as the password, the information being assigned to the input region from which the finger is released.

8. A password input method for a mobile terminal device comprising a display module including a display surface, a detection module configured to detect that the display surface has been touched, and a tactile sense information output module configured to output tactile sense information, the password input method comprising:
setting a plurality of input regions on the display surface, information constituting a password being assigned to each of the input regions;
determining, based on a detection result by the detection module, whether or not any of the input regions has been touched; and
when any of the input regions has been touched, making the tactile sense information output module output the tactile sense information corresponding to the information assigned to the touched input region.
